(19) United States
(12) Patent Application Publication
(10) Pub. No.: US 2019/0240532 A1
(43) Pub. Date: Aug. 8, 2019

(54) Adjustable Handlebars

(71) Applicant: Mobility Research, Inc., Tempe, AZ (US)

(72) Inventors: Ryan BELLMAN, Tempe, AZ (US); Dave DILLI, Phoenix, AZ (US); Mohammad Ehsan, Phoenix, AZ (US); Amir SEIF-NARAGHI, Phoenix, AZ (US)

(73) Assignee: Mobility Research, Inc., Tempe, AZ (US)

(21) Appl. No.: 15/891,779

(22) Filed: Feb. 8, 2018

(51) Int. Cl. A63B 22/02; F16C 11/10; A63B 23/04

(52) U.S. Cl. CPC A63B 22/02; A63B 2225/09; A63B 23/0405; F16C 11/10

(57) ABSTRACT

Right and left arms are rotatably connected to stanchions form adjustable handlebars. The arms are shaped such that rotating them changes the height and their width apart, enabling the gait training or exercise device to accommodate users of different height and girth. Each arm is shaped like an abbreviated “S”. A fastener holds each arm in a desired angle of rotation, holding the handlebars at a given height and distance apart. The position can be changed be releasing the fastener, moving the arm to a new desired position, and re-securing the fastener. In a preferred embodiment, the fastener comprises a spring-biased knob, external splines at the end of the arm, and internal splines inside a receiving tube on the frame of the exercise device, which cooperate to fix a handle bar in a desired position.

### FIELD OF INVENTION

This invention relates generally to handlebars that adjust to different heights and widths. This invention relates more particularly to adjustable handlebars that are used in connection with exercise equipment such as gait training devices.

### BACKGROUND

Exercise equipment often uses handlebars to help the user maintain balance while exercising. For best balance, the handlebars need to be at the proper height and width for a given user. For gait training equipment in particular, the handles need to be relatively close to the user so the user can maintain his balance and center of gravity without having to extend his arm or body very far from his body.

Typically handlebars are in a fixed position and, for manufacturing reasons, that position is set to accommodate the average user's height and girth. They cannot be adjusted to accommodate a user's height or girth, so for users that are shorter, taller, wider or more slender than the average user, the handle bars do not satisfactorily help the user maintain balance. It would be desirable to have handlebars that easily adjust to different heights and widths.

### SUMMARY OF THE INVENTION

This invention satisfies the need for handlebars that easily adjust to different heights and widths. Right and left arms are rotatably connected to stanchions. The arms are shaped such that rotating them changes the height of the handlebars and the width apart, thereby enabling the gait training or exercise device to accommodate users of different height and girth. The degree of rotation of each arm can be temporarily fixed, thereby holding the handlebars at a given height and distance apart. Each arm is shaped like an abbreviated “S,” a tube with two bends. A fastener holds each arm in a desired position. The arm position can be changed by releasing the fastener, moving the arm to a new desired position, and re-securing the fastener. In a preferred embodiment, the fastener comprises a spring-biased knob, external splines at the end of the arm, and internal splines inside a receiving tube on the frame of the exercise device, which cooperate to fix a handle bar in a desired position.

### BRIEF DESCRIPTION OF THE DRAWINGS

FIG. 1 is a side view of a handlebar.

FIG. 2 is a top view of the handlebar of FIG. 1.

FIG. 3 is an end view of the handlebar of FIG. 1.

FIG. 4A is a perspective view of the splined fitting.

FIG. 4B is a side view of the splined fitting of FIG. 4A.

FIG. 4C is an end view of the splined fitting of FIG. 4A.

FIG. 5 is an end view of the receiving tube with the arm removed.

FIG. 6A is a side view of the knob cooperating with the splines.

FIG. 6B is a cross-sectional view of the knob cooperating with the splines.

FIG. 7 is a perspective view of the arm in a receiving tube on a bracket.

FIG. 8 is a front view of a gait trainer with handlebars in various positions.

FIGS. 9A-F illustrate perspective views of a gait trainer with handlebars set in several positions.

### DETAILED DESCRIPTION OF THE INVENTION

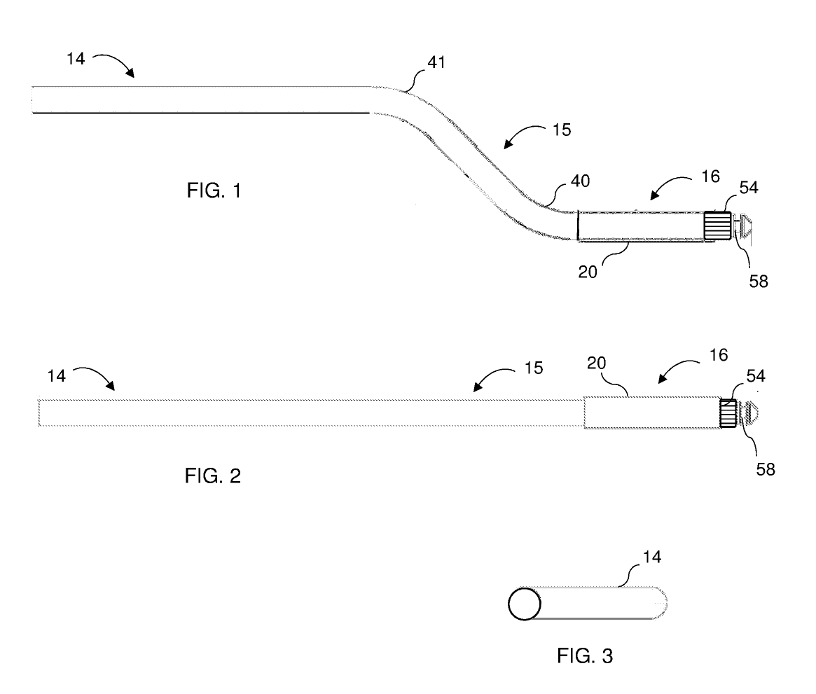

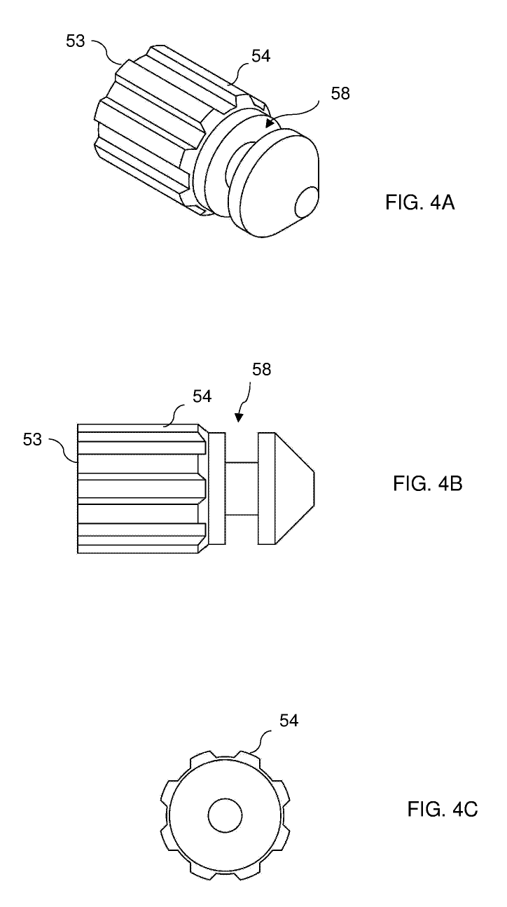

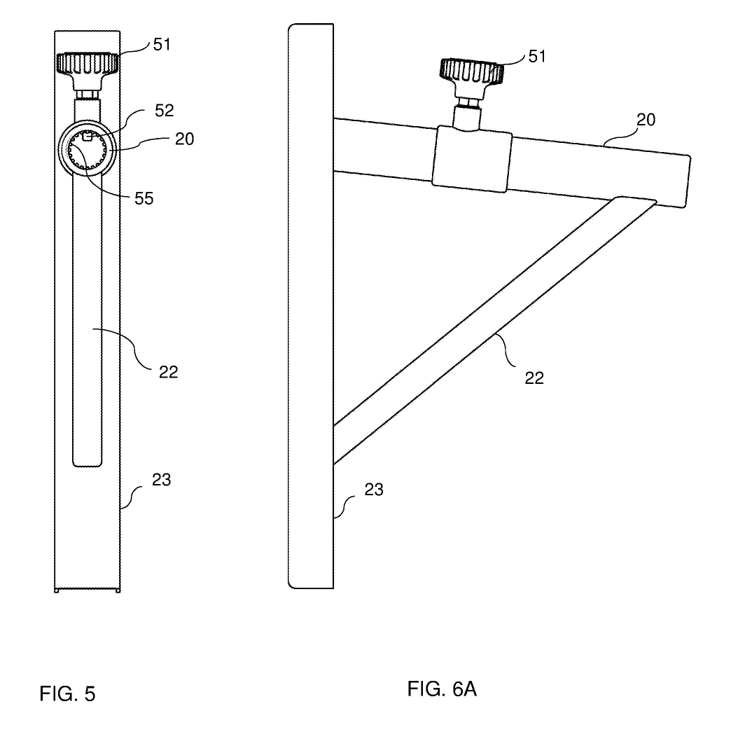

This invention provides adjustable handlebars to accommodate users of different heights and girths. The handlebars comprise a right arm 11 and a left arm 12, each made of a tube or rod that is shaped like an abbreviated “S” or dogleg. See FIG. 1. The portions of the “S” are referred to herein as the handle portion 14, the middle portion 15, and the attachment portion 16. Each arm is bent at a first angle 40 between the attachment portion 16 and the middle portion 15 and bent at a second angle 41 between the middle portion 15 and the handle portion 14. Preferably the bends are in the same plane so that all portions of the arm are in the same plane. FIG. 2 shows the top of an arm and FIG. 3 shows the end of an arm, with all arm portions in the same plane. Preferably the bends are such that the handle portion 14 remains parallel to the attachment portion 16 and preferably both arms have the same shape. In another embodiment, one arm may have a different shape from the other, for example where the bends in one arm are at different angles than those of the other arm. In another embodiment, each arm may have only a single bend so that the arm is shaped more like an “L”.

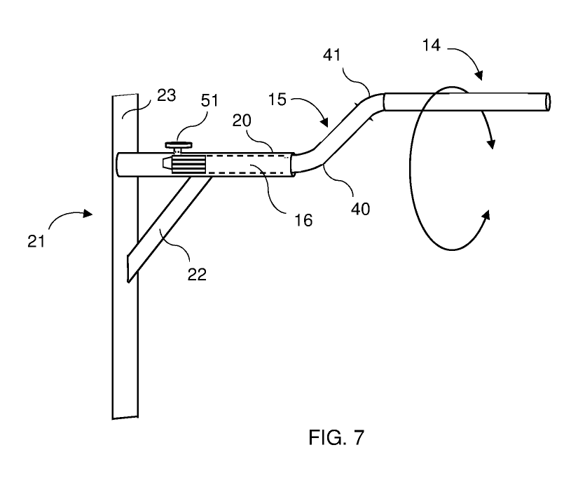

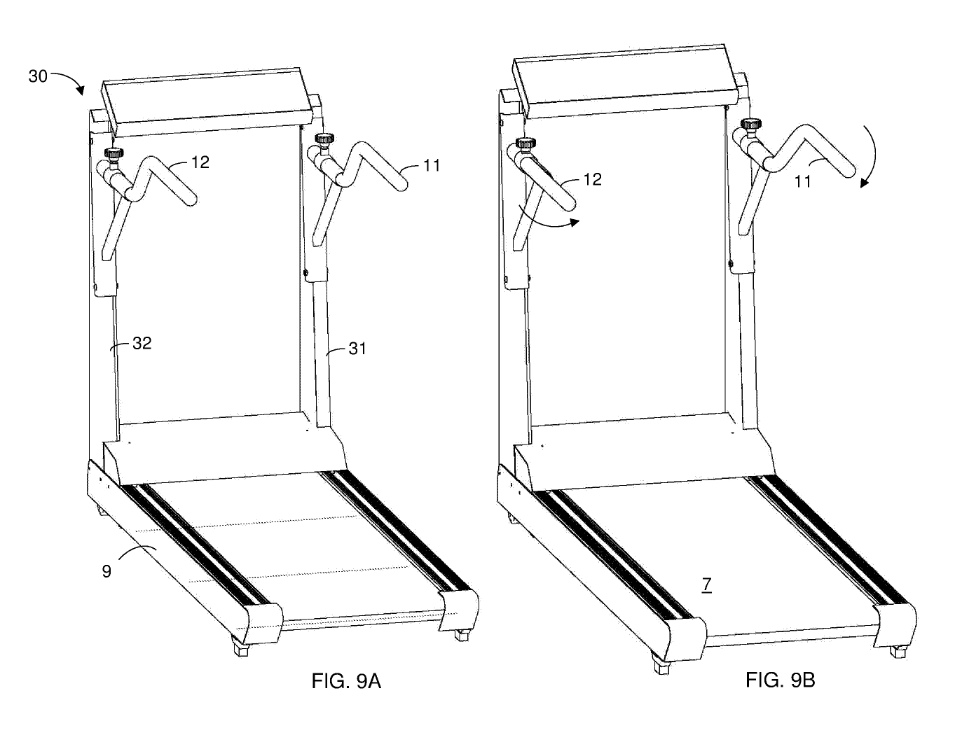

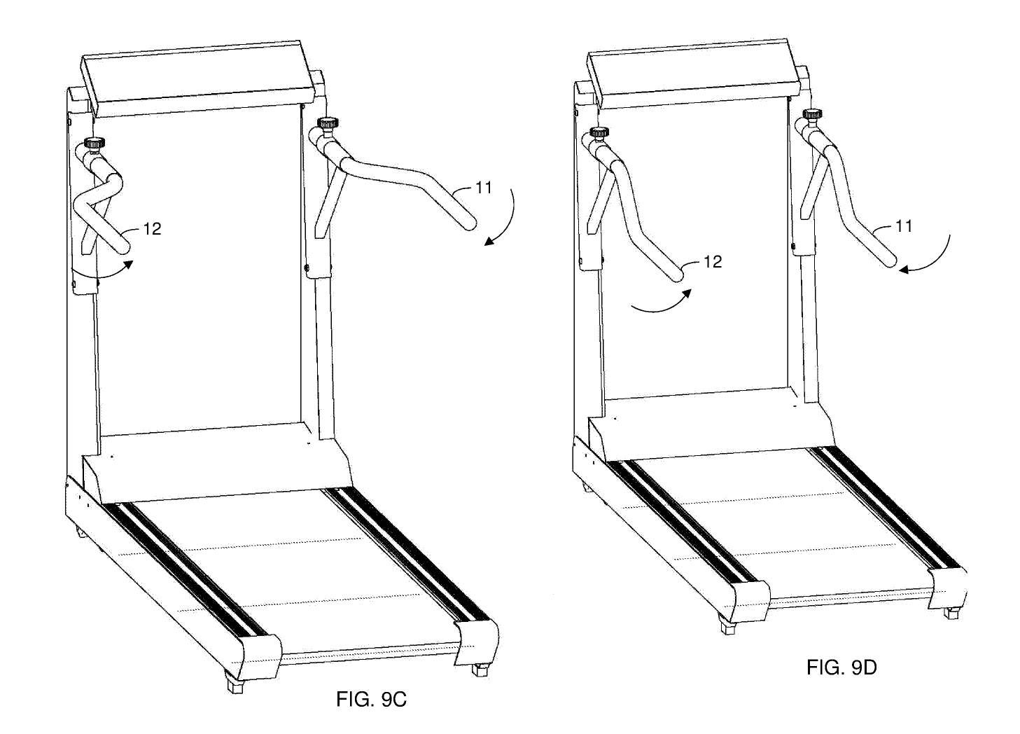

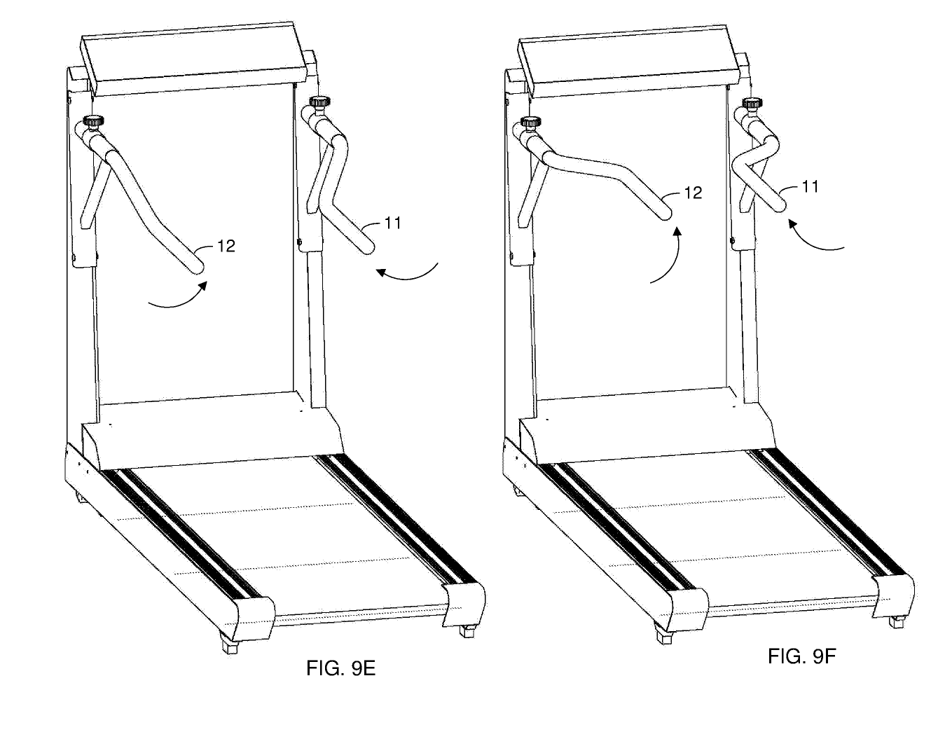

The attachment portion of each arm 11, 12 is rotatably connected to the exercise device. In a preferred embodiment, the exercise device is a gait training device comprising stanchions 31 and 32 in a frame 30, which is attached to a base 9 that rests on the ground. A treadmill belt 7 may be operably attached to the frame 30. See FIGS. 8 and 9A-F. In this preferred embodiment, each arm 11, 12 is attached to a stanchion 31, 32 with a bracket 21. The bracket 21 comprises a flange 23, a support arm 22, and a hollow receiving tube 20. See FIGS. 5 and 7. The receiving tube 21 receives the attachment portion 16 of the arm. Each arm is independently rotatable around the end of its attachment portion 16. Due to the shape of each arm, rotation of either arm away from an initial position causes the end of the handle portion 14 of one arm to be a different distance from the end of the handle portion 14 of the other arm than the distance apart they were at the initial position. In an alternative embodiment, the arms are rotatably attached directly to the exercise device.

The degree of rotation of each arm can be temporarily, but securely, fixed at a given position with a fastener, thereby holding the handlebars at a given height and distance apart. The position can be changed be releasing the fastener, moving each arm to a new desired position, and re-securing its fastener. In one embodiment, the fastener is a cotter pin, weight stack pin, detent, or like device that cooperates with holes disposed in the circumference of the end of the attachment portion of the arm and holes disposed in the circumference of the end of a receiving tube to fix the arm in the desired position.

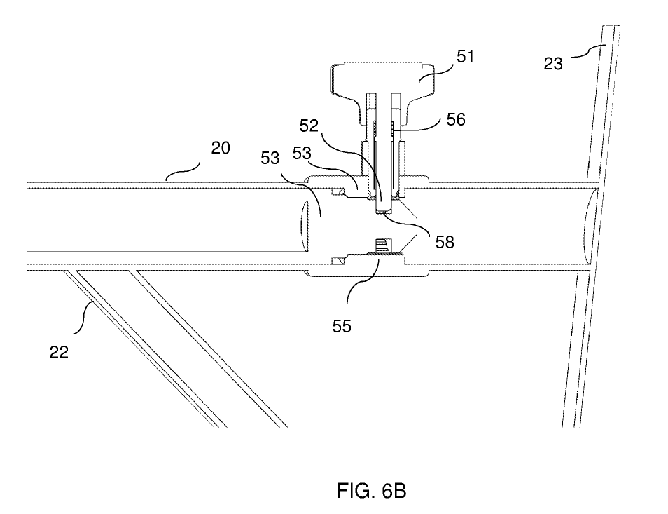

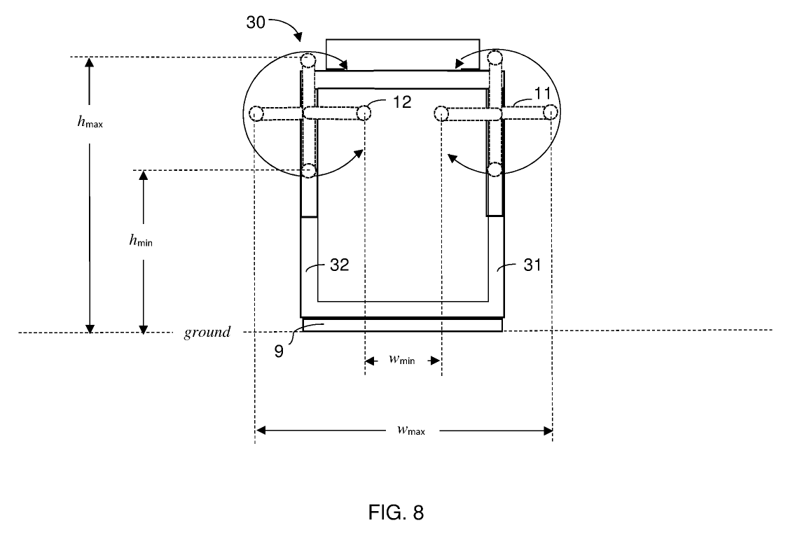

In a preferred embodiment, the fastener comprises a spring-biased knob 51, external splines 54 at the end of the attachment portion 16 of the arm, and internal splines 55 inside the receiving 20 tube to fix the arm in the desired position. The external splines 54 and internal splines 55 are disposed parallel to each other and parallel to the lengthwise axis of the arm and receiving tube, respectively. See FIGS. 4A-C, 5 and 6A-B. In one embodiment the external splines are integral with the arm and in a preferred embodiment the external splines are on a shaft 53 attached to the arm. See FIG. 4. The end of the arm or, preferably the shaft 53, has a circumferential notch 58 for receiving the stem 52 of the knob 51 through a stem hole in the receiving tube. See FIG. 6. The internal splines 55 are inside the end of receiving tube 20. See FIG. 5. The ends of the internal splines 55 may be cut back at 45 degrees, which makes it easier for the external and internal splines to fit into each other. When at rest, the external splines 54 and the internal splines 55 intermesh to prevent the arm from rotating relative to the receiving tube, and the stem 52 of the knob 51 sits in the notch 58 in the shaft 53, preventing the arm from being pulled out of the receiving tube 20. The number of splines 54, 55 and their length and depth are chosen such that, when coupled, they are sufficient to prevent the arm from rotating, even when a patient's body weight is pressing on the arm. To reposition an arm, the knob 51 is pulled away from the receiving tube 20, compressing the spring 56 a sufficient distance to pull the stem out of the notch 58. The arm is then pulled out of the receiving tube far enough to disengage the external splines from the internal splines so that the arm can be rotated relative to the receiving tube. When the arm is rotated the desired amount, the arm is pushed back into the receiving tube so that the splines of the arm mate with the splines in the receiving tube. The knob is released, the spring relaxes, and the knob seats itself in the notch again so that the arm cannot be pulled out. The knob, external splines and internal splines cooperate to hold the arm in place.

FIGS. 8 and 9A-F shows a gait training device with the arms at various positions. The right arm 11 and left arm 12 are shaped such that rotation of the right handle portion 14R away from the left handle portion 14L increases the width w and rotation of the right handle end toward the left handle end decreases the width w. See FIG. 8. When the arms are rotated so that the handle portions are closest to one another, the width is at a minimum, wₘᵢₙ. Conversely, when the arms are rotated so that the handle portions are farthest apart from one another, the width is at a maximum, wₘₐₓ. When the arms are rotated so that the handle portions are closest to the ground, the height is at a minimum, hₘᵢₙ. Conversely, when the arms are rotated so that the handle portions are the farthest from the ground, the height is at a maximum, hₘₐₓ.

FIG. 9A shows both arms 11, 12 at rest at hₘₐₓ. FIG. 9B shows the right arm 11 rotated clockwise about 45 degrees and the left arm 12 rotated counterclockwise about 45 degrees from the position shown in FIG. 9A. FIG. 9C shows the right arm 11 rotated clockwise about 90 degrees and the left arm 12 rotated counterclockwise about 90 degrees from the position shown in FIG. 9A, at about wₘₐₓ FIG. 9D shows the right arm 11 rotated clockwise about 180 degrees and the left arm 12 rotated counterclockwise about 180 degrees from the position shown in FIG. 9A, at about hₘᵢₙ. FIG. 9E shows the right arm 11 rotated clockwise about 125 degrees and the left arm 12 rotated counterclockwise about 125 degrees from the position shown in FIG. 9A. Finally, FIG. 9F shows the right arm 11 rotated clockwise about 270 degrees and the left arm 12 rotated counterclockwise about 270 degrees from the position shown in FIG. 9A, at about wₘᵢₙ.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. Adjustable handlebars for a gait therapy device comprising:
a) a right arm comprising a right attachment portion having a right attachment end, a right middle portion, and a right handle portion having a right handle end, where the right arm is bent at a first angle between the right attachment portion and the right middle portion and bent at a second angle between the right middle portion and the right handle portion;
b) a left arm comprising a left attachment portion having a left attachment end, a left middle portion, and a left handle portion having a left handle end, where the left arm is bent at a third angle between the left attachment portion and the left middle portion and bent at a fourth angle between the left middle portion and the left handle portion;
c) wherein the right arm is rotatable around its right attachment end and the left arm is rotatable around its left attachment end such that rotation of either arm away from an initial position causes the right handle end to be a different distance apart from the left handle end than the distance apart at the initial position.

2. The handlebars of claim 1 wherein:
a) the first angle and second angle are such that the right handle portion is parallel to the right attachment portion; and
b) the third angle and fourth angle are such that the left handle portion is parallel to the left attachment portion.

3. The handlebars of claim 1 further comprising:
a) a right fastener that temporarily secures the right arm in a first right rotation; and
b) a left fastener that temporarily secures the left arm in a first left rotation.

4. The handlebars of claim 3 wherein:
a) the gait therapy device comprises a frame;
b) the right fastener temporarily secures the right arm in the first right position in a right receiving tube that is attached to the frame; and
c) the left fastener temporarily secures the left arm in the first left position in a left receiving tube that is attached to the frame.

5. The handlebars of claim 4 wherein:
a) the right fastener further comprises these cooperating elements:
i. right external splines at the right attachment end;
ii. right internal splines inside the right receiving tube disposed to receive the right attachment end; and
iii. a right spring-biased knob; and
b) the left fastener further comprises these cooperating elements:
i. left external splines at the left attachment end;
ii. left internal splines inside the left receiving tube disposed to receive the left attachment end; and
iii. a left spring-biased knob.

6. The handlebars of claim 4 wherein:
a) the right fastener further comprises a right spring-biased knob that cooperates with a notch or aperture in the right attachment end to temporarily prevent the right arm from being removed from the right receiving tube; and
b) the left fastener further comprises a left spring-biased knob that cooperates with a notch or aperture in the left attachment end to temporarily prevent the left arm from being removed from the left receiving tube.

7. Adjustable handlebars for a gait therapy device comprising:
a) a right arm having a right first end and a right second end, the right arm rotatably attached to a frame and the right arm having at least a first bend between the right first end and the right second end;
b) a left arm having a left first end and a left second end, the left arm rotatably attached to the frame and the left arm having at least a second bend between the left first end and the left second end;
c) wherein rotation of either arm away from an initial position causes the right second end to be a different distance apart from the left second end than the distance apart at the initial position.

8. The handlebars of claim 7 further comprising:
a) a right fastener that temporarily secures the right arm in a first right position; and
b) a left fastener that temporarily secures the left arm in a first left position.

9. The handlebars of claim 8 wherein:
a) the gait therapy device comprises a frame;
b) the right fastener temporarily secures the right arm in the first right position in a right receiving tube that is attached to the frame; and
c) the left fastener temporarily secures the left arm in the first left position in a left receiving tube that is attached to the frame.

10. The handlebars of claim 9 wherein:
a) the right fastener further comprises a right spring-biased knob that cooperates with a notch or aperture in the right first end to temporarily prevent the right arm from being removed from the right receiving tube; and
b) the left fastener further comprises a left spring-biased knob that cooperates with a notch or aperture in the left attachment end to temporarily prevent the left arm from being removed from the left receiving tube.

11. The handlebars of claim 9 further wherein:
a) the right fastener further comprises these cooperating elements:
i. right external splines at the right first end;
ii. right internal splines inside the right receiving tube disposed to receive the right attachment end; and
iii. a right spring-biased knob; and
b) the left fastener further comprises these cooperating elements:
i. left external splines at the left first end;
ii. left internal splines inside the left receiving tube disposed to receive the left attachment end; and
iii. a left spring-biased knob.

12. Adjustable handlebars for a gait therapy device comprising:
a) a frame disposed on the ground, the frame comprising a base connected to a right stanchion and a left stanchion disposed apart from each other;
b) a right arm having a right attachment end and a right handle end, the right arm rotatably connected at the right attachment end to the right stanchion; and
c) a left arm having a left attachment end and a left handle end, the left arm rotatably connected at the left attachment end to the left stanchion;
wherein the distance between the right handle end and left handle end is a width; and
d) the right arm and left arm are shaped such that rotation of the right handle end away from the left handle end increases the width and rotation of the right handle end toward the left handle end decreases the width.

13. The handlebars of claim 12 wherein:
a) the distance between the ground and the right handle end is h_{right} and the distance between the ground and the left handle end is h_{left}; and
b) the shapes of the right arm and left arm are such that rotation of the right handle end changes h_{right} and the rotation of the left handle end changes h_{left}.

14. The handlebars of claim 12 further comprising:
a) a right fastener that temporarily secures the right arm in a first right position in a right receiving tube attached to the right stanchion; and
b) a left fastener that temporarily secures the left arm in a first left position in a left receiving tube attached to the left stanchion.

15. The handlebars of claim 14 wherein:
a) the right fastener further comprises these cooperating elements:
i. right external splines at the right attachment end;
ii. right internal splines inside the right receiving tube disposed to receive the right attachment end; and
iii. a right spring-biased knob; and
b) the left fastener further comprises these cooperating elements:
i. left external splines at the left attachment end;
ii. left internal splines inside the left receiving tube disposed to receive the left attachment end; and
iii. a left spring-biased knob.

16. The handlebars of claim 12 wherein:
a) the right arm is bent at a first angle between the right attachment end and a right middle portion and bent at a second angle between the right middle portion and the right handle end; and
b) the left arm is bent at a third angle between the left attachment end and a left middle portion and bent at a fourth angle between the left middle portion and the left handle end.

17. The handlebars of claim 12 further comprising a treadmill belt attached to the base.
